(19) United States
(12) Patent Application Publication
(10) Pub. No.: US 2008/0217322 A1
(43) Pub. Date: Sep. 11, 2008

(54) Printing Plate Ovens

(75) Inventors: Alan Craig Nicholl, Halifax (GB); John Cruse, Bradford (GB)

Correspondence Address: MOORE & VAN ALLEN PLLC, P.O. BOX 13706, Research Triangle Park, NC, 27709, US

(73) Assignee: HEIGHTS (UK) LIMITED, West Yorkshire (GB)

(21) Appl. No.: 10/577,788

(22) PCT Filed: Oct. 28, 2004
(86) PCT No.: PCT/GB2004/004555

§ 371 Date: Feb. 21, 2008

(30) Foreign Application Priority Data
Oct. 31, 2003 (GB) 0325459.6

(51) Int. Cl. H05B 3/06

(52) U.S. Cl. 219/520

(57) ABSTRACT

The present invention relates to a printing plate oven 10 designed for lithographic printing plates and, in particular, for baking Kodak DITP gold printing plates. The printing plates oven comprises heating apparatus including a number of heating elements which extend at an angle relative to the direction of a printing plate passing through the oven. The printing plate oven also comprises drive means for driving the printing plates in which two rollers are urged towards each other on either side of the printing plates but the rollers are profiled such that they do not simultaneously contact a part of the printing plate at directly opposite locations. The printing oven includes cooling means which comprise deflecting means in order to flex a part of the printing plate during cooling. Furthermore, the heating elements of the printing oven are controlled in order to vary the heat applied to the printing plate depending upon the position of the printing plate.

### FIELD OF THE INVENTION

The present invention relates to heating apparatus for a printing plate oven, a method of heating printing plates in a printing plate oven, drive means for printing plates, a method of driving a printing plate, cooling means for use with a printing plate oven, a method of cooling a printing plate, control means for heating apparatus for a printing plate oven, a method of controlling the heat of heat apparatus of a printing plate oven, temperature regulation means for a printing plate oven and a method of regulating the ambient temperature in a printing plate oven.

### BACKGROUND TO THE INVENTION

Lithographic printing plates may have an approximate lifespan of approximately 50,000 to 250,000 prints or impressions. However, if the lithographic printing plates have been baked then the lithographic printing plates may be used for approximately 1 million to 1.5 million prints or more. Accordingly, it is highly advantageous to use baked lithographic printing plates and in particular when producing numerous identical images.

Prior art ovens for lithographic printing plates may heat a lithographic printing plate unevenly. This may result in part of the lithographic printing plate deteriorating quicker than other parts of the plate. Accordingly, the lifespan of the lithographic printing plate will not be as great as an evenly heated lithographic printing plate.

Furthermore, when lithographic printing plates are cooled, the surface of the lithographic printing plate may be caused to ripple. This uneven surface will reduce the quality of the prints subsequently obtained from the lithographic plates.

It is an aim of the present invention to overcome at least one problem associated with the prior art whether referred to herein or otherwise.

### SUMMARY OF THE INVENTION

According to a first aspect of the present invention there is provided heating apparatus for a printing plate oven comprising at least one heating element extending in a first direction wherein a printing plate is arranged, in use, to pass the heating element in a second direction which is at an angle to the first direction.

The heating element may comprise a substantially linear heating element. Preferably the linear (heating) element comprises a longitudinal axis which extends at (or in) the first direction.

Preferably the heating apparatus is arranged, in use, to be located in an oven compartment of a printing plate oven.

Preferably the printing plate is arranged, in use, to pass underneath the or each heating element.

Preferably the heating apparatus comprises a plurality of heating elements. Preferably each heating element comprises a longitudinal axis which extends in the first direction. Preferably the longitudinal axes of each heating element are parallel.

Preferably the or each heating element comprises a lamp. Preferably the or each heating element comprises an infra-red lamp. The or each lamp is powered by an electrical supply and preferably by a pulsated electrical supply.

The or each lamp may comprise a halogen lamp.

The or each lamp may comprise an elongate lamp.

Preferably the lamp is pulsated in order to control the heat generated by the respective lamp.

The angle between the first direction and the second direction may be greater than 15° and preferably is greater than 30° and more preferably is greater than or equal to substantially 45°.

The angle between the first direction and the second direction may be less than 80° and preferably is less than 75° and more preferably is less than or equal to substantially 70°.

Preferably the heating elements are arranged spaced apart laterally across the heating apparatus.

Preferably, if a part of a printing plate passes underneath a first end of a first heating element, then said part of the printing plate passes underneath a second end of a second (adjacent) heating element.

Preferably the or each heating element comprises a first end which is located upstream of second end of the respective heating element such that a printing plate is arranged, in use, to pass underneath the first end of the heating element and subsequently underneath the second end of the heating element.

The heating apparatus may comprise a first group (a central group) of heating elements located centrally laterally in the heating apparatus and one or more lateral or side groups (at least one right group and/or at least one left group) of heating elements located adjacent to the lateral edges of the heating apparatus. There may be two, four, six, eight or any suitable member of lateral or side groups.

The heating apparatus may comprise side heating element(s). The side heating element(s) may have a longitudinal length less than a non-side heating element, for example, a central heating element.

The or each heating element may comprise reflecting means. The or each reflecting means may be located adjacent to, and preferably is located above the respective heating element or lamp. The reflecting means may comprise a reflector. The reflecting means may comprise a first side wall and a second side wall in order to direct the heat. The reflecting means may comprise an upper wall located uppermost in the reflecting means and may locate between the upper portions of the respective side walls. The reflecting means may prevent and/or inhibit the heat being reflected radially outwardly from the heating element and preferably from the respective lamp. Preferably the reflecting means maintains and reflects the heat radially out from the respective heating element (and preferably from the respective lamp) within an angle. The angle may be greater than 30° and preferably is greater than 45° and more preferably is greater than 60°. The angle may be less than 180° and preferably is less than 135° and more preferably is less than 90°. The angle may be substantially 80°. Preferably the reflecting means reflects the heat downwardly towards an upper surface of a printing plate, in use.

The heating apparatus may comprise an array of heating elements wherein the longitudinal axes of the heating elements are parallel. The heating elements may form a herring bone pattern within the heating apparatus.

The heating apparatus may comprise cooling means. The cooling means may be arranged, in use, to cool the or each heating element. Each heating element may have cooling means associated therewith. The or each cooling means may comprise a fan. The or each cooling means may dissipate heat away from the heating element and/or reflecting means.

The reflecting means may be arranged such that the heat reflected from a first heating element overlaps on a surface of a printing plate, in use, with the heat reflected from an adjacent heating element. The overlapping portion may be greater than 5 mm. The overlapping portion may be less than 10 mm. The overlapping portion may be substantially 7 mm.

According to a second aspect of the present invention there is provided a method of heating printing plates in an oven compartment of a printing plate oven comprising heating at least one heating element wherein the heating element extends in a first direction and moving a printing plate passed the heating element in a second direction which is at an angle to the first direction.

The method may comprise passing the printing plate underneath the heating element.

The method may comprise providing a plurality of heating elements in the heating apparatus.

The method may comprise providing an array of heating elements in a herring bone pattern in the heating apparatus.

According to a third aspect of the present invention there is provided drive means for a printing plate, the drive means being arranged, in use, to drive a printing plate wherein the drive means comprises a first roller and the first roller comprises an outer surface for contacting the printing plate in which the outer surface of the roller comprises at least one raised portion.

Preferably the drive means is for use in a printing plate oven. The drive means may drive a printing plate into and/or out of and/or through a printing plate oven and preferably an oven compartment of a printing plate oven.

Preferably the first roller comprises a drive roller which is driven.

Preferably the outer surface of the first roller comprises a plurality of raised portions.

Preferably the or each raised portion extends radially around the outer surface of the first roller and preferably completely radially around the outer surface of the first roller to provide a cylindrical support surface.

Preferably the first roller has a longitudinal axis that extends laterally across the printing plate oven.

Preferably in a longitudinal cross-section, an upper surface and/or a lower surface of the first roller comprise castellated surfaces.

Preferably the drive means comprises urging means to urge the printing plate towards the first roller, in use. The urging means may comprise a second roller. Preferably, the outer surface of the second roller is spaced from the outer surface of the first roller. The outer surface of the second roller may be spaced from the outer surface of the first roller by a distance slightly less than the thickness of a printing plate to be driven therethrough.

The second (or urging) roller may be biased relatively towards the first roller.

The outersurface of the drive roller may comprise a deformable or resilient material.

The outersurface of the second (or urging) roller may comprise a deformable or resilient material.

The drive means may comprise adjustment means to adjust the separation distance between the outersurface of the first (or drive) roller and the outersurface of the second (or urging) roller.

Preferably the drive means comprises adjustment means to adjust the urging force between the first (or drive) roller and the urging means (or urging/second roller).

Preferably the first roller is located below the second roller, in use.

The urging means may comprise an urging (or second) roller wherein the outer surface of the urging (or second) roller comprises at least one raised portion. Preferably the or each raised portion on the urging (or second) roller extends radially around the outer surface of the urging (or second) roller. Preferably the urging (or second) roller has an outer surface contoured or shaped identical to the first roller but may have raised portion(s) which are off set longitudinally along the urging (or second) roller and preferably to cause (or in order for) a raised portion in one roller to locate within a channel portion defined between two adjacent raised portions on the other roller.

The outer surface of the urging (or second) roller may comprise a plurality of channel portions.

Preferably the printing plate is arranged, in use, to be driven between an outer surface of the drive (or first) roller and an outer surface of the urging means (or urging/second roller).

Preferably the drive (or first) roller is arranged, in use, to locate directly vertically below the urging means (or urging/second roller), in use.

Preferably the drive (or first) roller extends along a longitudinal axis. Preferably the urging means (or second/urging roller) extends along a longitudinal axis. Preferably the longitudinal axis of the drive (or first) roller is parallel to but vertically offset from the longitudinal axis of the urging means (or second/urging roller).

Preferably adjacent raised portions on the or each roller define a channel portions therebetween. Preferably the drive (or first) roller has raised portions which are offset laterally with raised portions of the urging means (or second/urging roller) and preferably are offset such that a part of a printing plate is not contacted simultaneously on both surfaces (i.e. simultaneously contacted on the upper surface and lower surface at the same point).

The urging (or second) roller may be resiliently biased towards the drive (or first) roller by resilient means, in use.

The resilient means may comprise a spring which urges the urging roller towards the drive (or first) roller once the drive (or first) roller is spaced from the urging (or second) roller by a distance greater than a set or predetermined distance.

According to a fourth aspect of the present invention there is provided a method of driving a printing plate the method comprising driving a roller to drive the printing plate wherein the roller comprises an outer surface for contacting the printing plate in which the outer surface of the roller comprises at least one raised portion.

The method may comprise urging the printing plate into contact with the outersurface of the roller.

The method may comprise passing the printing plate between two rollers wherein one of the roller is driven. The separation distance between the outersurface of a first roller and an outer surface of the second roller may be less than the thickness of the printing plate to be passed therebetween.

According to a fifth aspect of the present invention there is provided cooling means for use with a printing plate oven wherein the cooling means comprise deflection means in order to flex a part of a printing plate during cooling.

Preferably the cooling means applies a tensile force to a printing plate during cooling.

Preferably the deflection means comprises a deflection member.

The deflection means may comprise guide means.

Preferably the guide means guides the printing plate in a first direction and is arranged to guide the printing plate in order to abut the deflection member which flexes and deflects the printing plate in order for the printing plate to travel in a second direction and preferably for the printing plate to travel in a second direction towards a guide member.

Preferably the guide means comprises a first guide member and a second guide member.

Preferably the deflection means comprises a deflecting roller.

Preferably the printing plate is arranged to pass between the first guide member around at least a part of the deflecting roller (and preferably around an arcuate part of an outer surface of the deflecting roller) and to the second guide member.

Preferably the first guide member is spaced from the second guide member by a distance less than the longitudinal length of the printing plate.

Preferably the printing plate is flexed laterally across the width thereof during cooling.

Preferably the deflecting roller comprises a driven deflecting roller.

The deflecting roller may comprise a non-driven roller and may comprise a free rotating roller.

According to a sixth aspect of the present invention there is provided a method of cooling a printing plate comprising flexing at least a part of the printing plate during cooling.

Preferably the method comprises tensing at least a part of the printing plate during cooling.

Preferably the method comprises flexing the printing plate over a lateral direction.

According to a seventh aspect of the present invention there is provided heating apparatus for a printing plate oven comprising heating apparatus and control means wherein the control means is arranged, in use, to control the heat of the heating apparatus relative to a part of a printing plate passing therethrough.

Preferably the part comprises a section which may be defined on the printing plate due to the location of the port relative to its longitudinal and/or lateral position on the printing plate.

Preferably the control means is arranged, in use, to control the heat of the heating apparatus relative to the longitudinal position of the printing plate which is located in the heating apparatus.

The heating apparatus may be arranged to simultaneously provide a first temperature to one part of the printing plate and a second temperature to another part of the printing plate and preferably also (to simultaneously provide) a temperature to a third part of the printing plate.

The control means may control the heat of the heating apparatus in a first period which may be an entry period.

The heat may comprise a first temperature.

The control means may control the heat of the heating apparatus in a second period which may be an exit period.

The heat may comprise a second temperature.

The control means may control the heat of the heating apparatus in a third period which may be an intermediary period between the entry period and the exit period.

The heat may comprise a third temperature.

The control means may be arranged to control the heat of the heating apparatus in a plurality of periods or sections whilst the printing plate is passing through the heating apparatus. There may be 1,2,3,4,5,6,7,8,9 such periods or sections. There may be more than 9 periods or sections.

The control means preferably controls the heat supplied by a heating element or plurality of heating elements in the heating apparatus.

Preferably the control means in arranged to control the heat applied to a printing plate passing therethrough relative to the longitudinal location of the printing plate located within the heating apparatus.

The control means may be arranged to control the heat applied to a part of a printing plate passing therethrough dependent upon the lateral position of the part of the printing plate.

The control means may be arranged to supply heat to a printing plate such that the printing plate is defined in a plurality of zones wherein each zone is arranged to be supplied with a different amount of heat.

The printing plate may be divided into a plurality of lateral sections (for example 3, 5, 7, 9 or another other suitable odd number) such that the heat supplied to outermost side sections is greater than that applied to the other sections which may include a single central section, located between the outermost side sections.

The printing plate may be divided into two, three or more longitudinal sections such that the heat applied to a front section is greater than the heat applied to a rear section and also to any other intermediary sections.

The printing plate may be divided such that an intermediary section (or a plurality of intermediary sections) locates between the front section and the rear section. The heat applied to the intermediary section may be less than that applied to the front section but may be greater than that applied to the rear section.

The heating apparatus may comprise a plurality of heating elements. The heating elements may be arranged into groups. The heating apparatus may comprise at least one central group and two lateral groups. The heating apparatus may comprise a plurality of central groups of heating elements. The heating elements in a group may all generate the same heat output. Preferably the heating elements are powered by a pulsated electrical supply. The percentage of “on” time and the percentage of “off” time may be identical for each heating element with any one group. Preferably this percentage defines the heat output of the or each heating element.

According to an eighth aspect of the present invention there is provided a method of controlling heating apparatus of a printing plate oven comprising controlling the heat applied to the printing plate and varying the heat relative to a part of a printing plate passing through heating apparatus.

The method may comprise varying the heat laterally across the heating apparatus.

The method may comprise varying the heat as a printing plate passes therethrough in order to heat the printing plate dependent upon the longitudinal location of the printing plate in the heating apparatus.

According to a ninth aspect of the present invention there is provided ambient temperature regulation means for a printing plate oven comprising sensor means wherein the sensor means is arranged to sense the ambient temperature within an oven compartment of the printing plate oven and to cool the oven compartment of the printing plate oven when a predetermined ambient temperature is reached.

Preferably the ambient temperature regulation means comprises exhaust means. Preferably the exhaust means comprises a plurality of exhaust ports. Preferably the exhaust ports are operable in order to enable fluid communication between the oven compartment and an external atmosphere. The exhaust ports may be openable and closable to selectively enable fluid communication between the oven compartment and external atmosphere.

The means may comprise at least one exhaust port which is permanently open and preferably comprises two exhaust ports which are permanently open. The or each exhaust port which are permanently open may be located toward the lateral sides of the oven compartment. The external means may comprise at least one (and preferably two) exhaust ports which is openable and closable to selectively enable fluid to flow therethrough. The or each openable and closable exhaust ports may be located centrally in the oven compartment.

The or each exhaust port may be associated with fluid flow means in order to induce or cause fluid flow therethrough. The fluid flow means may comprise a fan.

The exhaust port(s), once opened, is arranged, to be closed when a predetermined ambient temperature has been reached for example when the ambient temperature has been reduced to a predetermined level.

Preferably the temperature regulation means is arranged to maintain the ambient temperature of the oven compartment within a predetermined range or below a set temperature relative to a selected ambient temperature. The temperature regulator means may be arranged, in use, to maintain the oven compartment within 1° C. of the selected ambient temperature of the oven compartment.

According to a tenth aspect of the present invention there is provided a method of regulating the ambient temperature in an oven compartment of a printing plate oven comprising sensing the ambient temperature within the printing plate oven and cooling the ambient temperature when a predetermined temperature is sensed by the sensing means.

The method may comprise exhausting part of the air of the oven section.

### BRIEF DESCRIPTION OF THE DRAWINGS

The preferred embodiments of the present invention will now be described by way of example only, with reference to the drawings that follow, in which:

FIG. 1 is a side cross-section of a preferred embodiment of a printing plate oven.

FIG. 2 is a plan view of a preferred embodiment of heating apparatus for a printing plate oven.

FIG. 3 is a plan view of a preferred embodiment of heating apparatus for a printing plate oven.

FIG. 4 is a front cross-section of a preferred embodiment of heating apparatus for a printing plate oven.

FIG. 5 is a front cross section of a part of a preferred embodiment of heating apparatus for a printing plate oven.

FIG. 6 is a schematic view of a printing plate showing a preferred embodiment a preferred embodiment of in relation exposure to heat by a preferred embodiment of control means for a printing plate oven.

FIG. 7 is a perspective partially exploded front view of a preferred embodiment of drive means for a printing plate oven.

FIG. 8 is a cross-section of a preferred embodiment of a drive roller for a printing plate oven.

FIG. 9 is a front view of a preferred embodiment of drive means for a printing plate oven.

FIG. 10 is a plan view of an embodiment of exhaust ports from within a preferred embodiment of an oven compartment.

FIG. 11 is a diagram showing the relative heat applied to a printing plate along the longitudinal length of the printing plate in a preferred embodiment of a printing plate oven.

FIG. 12 is a diagram showing the relative heat applied to a printing plate along the lateral width of the printing plate in a preferred embodiment of a printing plate oven.

FIG. 13 in a partial cross-section of an embodiment of a drive roller and an urging roller showing offset raised portions.

FIG. 14 is a partial cross-section of another embodiment of a drive roller or urging roller.

FIG. 15 is a side schematic view of a printing plate passing through a preferred embodiment of cooling means.

FIG. 16 is a side schematic view of a printing plate passing through a preferred embodiment of cooling means.

### DESCRIPTION OF THE PREFERRED EMBODIMENTS

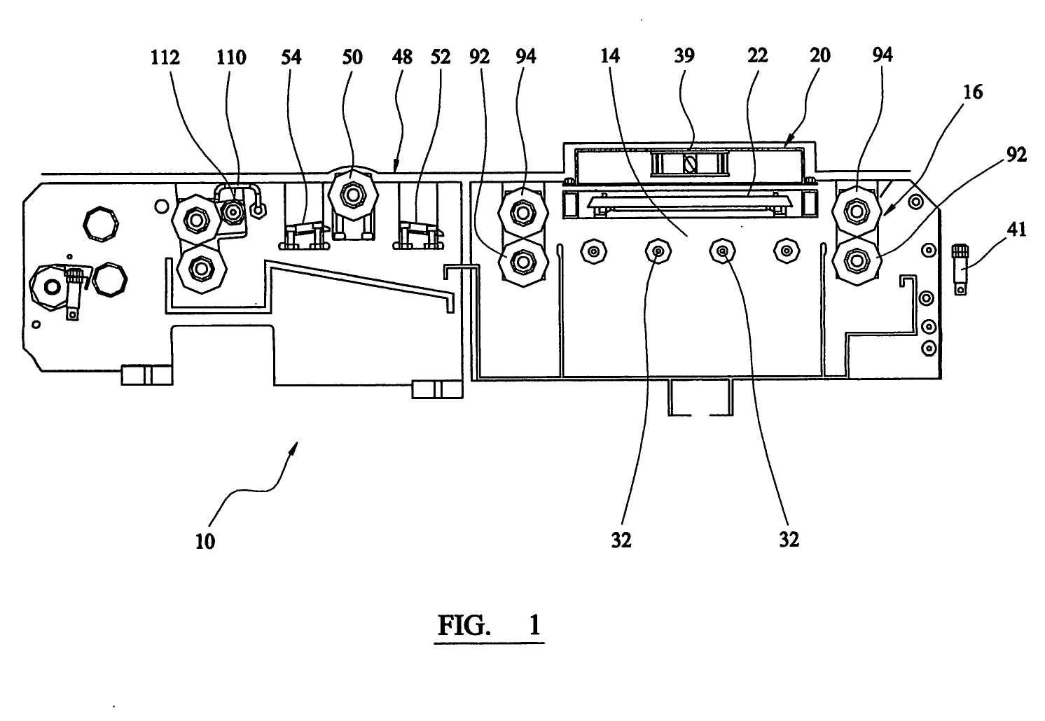

The present invention relates to a printing plate oven 10 as shown in FIG. 1. The printing plate oven 10 is designed for lithographic printing plates and in particular for baking Kodak DITP gold printing plates. The printing plate oven 10 may be adjusted for other printing plates, for example flexigraphic printing plates as well as other lithographic printing plates. The printing plate oven 10 comprises an oven compartment 14 and a cooling means 48 to cool the printing plates 12. In a preferred embodiment, the printing plate oven 10 may also comprise a finishing section to finish the printing plates 12 by applying gum and drying. This thereby provides automatic apparatus for preparing printing plates 12 and an automatic process and method therefore preparing printing plates 12. However, in alternative embodiments, the printing plate oven may not include the printing apparatus and just provides the oven compartment 14 and cooling means 48.

The printing plate oven 10 is an automatic printing plate baking system designed for use with DITP gold printing plates. Such machines are generally available in two sizes: 1250 and 1550, indicating the maximum width in mm of plates, which can be baked. However, other suitable plates could also be used with the present invention. Briefly, the printing plate oven 10 bakes, gums and then dries the printing plates.

The unit is operated by a microprocessor based control system and LCD operator panel providing simple, easy to use operator controls.

The following process is started whenever a printing plate is detected by sensor means 41 comprising an optical sensor at the infeed. The infeed sensor 41 starts the baking process as the printing plate 12 passes over it.

The printing plate 12 is gripped by drive means comprising a pair of spring adjusted anti static rollers which transport the plate at a constant speed and in particular between 1m and 1.3m per minute. The lower rollers have a castellated profile which allows residual heat to be quickly removed. The unit measures the plate length and controls the level of power delivered to the plate surface by lamps in the heating apparatus. The printing plate 12 is gripped by drive means comprising rollers 92, 94 which drive and feed the printing plates 12 into the temperature-controlled oven compartment 14, where heating apparatus 20 comprising a plurality of heating elements 22 in the form of lamps 24 and associated reflectors 34 (preferably short wave infra red lamps) bake the printing plates 12 in a controlled manner. The IR lamps are split into three separate control areas (LEFT, INNER, RIGHT) and powers are switched at three stages (FRONT, MID, BACK) during the baking process. This gives nine separate controlled areas of bake on the plate thus ensuring an even bake. However, the number of areas may be varied, for example to account for different sized and/or shaped and/or material of the printing plates 12.

The temperature of the oven compartment 14 is closely controlled by control means. A temperature probe is fitted within the extraction line and maintains an even ambient temperature while the unit is not being used and also throughout the baking process. There are two extraction fans which are separately controlled by the control means in order to regulate the ambient temperature in the oven. These extract heat and fumes from four areas within the oven compartment 14. The outer extraction fan runs constantly and is used the control the oven compartment 14 ambient. The inner extraction fan is used when a plate is being baked thus limiting the increasing oven compartment 14 ambient as printing plates are stream fed.

The external extraction system provides the removal of fumes and hot air from the oven compartment 14 printing plate oven 10 under control. This system allows a constant extraction without changing oven compartment 14 conditions which would result in uneven bake conditions.

After the printing plate 12 leaves the oven compartment 14 it is allowed to cool while controlling and eliminating deformation using cooling means 48 whilst flexing or tensing the printing plate during cooling. The printing plate 12 then passes into a gum section. The gum is then delivered from a spray bar 110 and is spread via a spiral applicator roller 112, allowing the final gum rollers to produce a thin even film of gum on the printing plate 12. Gum is contained in an external container. It is fed by a pump to a spray bar, which applies gum onto a spiral applicator roller and gum exit rollers. The gum then drains back to the container.

Gum flushing is provided via a gum flush pump, which takes water from a bottle and feeds directly into the gum spray bar. This is done to ensure that the feed nozzles are clear when the unit starts and closes down.

Finally, the printing plate 12 is dried on both sides by powerful jets of air. As the plate leaves the gum section, it passes via two delivery tubes which evenly direct powerful jets of air, which effectively dry the gum to provide protection to the baked plate. The dryer fan is switched on and off automatically whenever a plate is processed.

Once a printing plate 12 has been through the oven compartment, the temperature of the oven compartment 14 is allowed to stabilise prior to baking another printing plate.

The printing plate oven 10 is capable of providing a full bake. However it can provide run lengths in excess of 1 million with a partial bake.

If the machine is not being used for long periods of time a control system will exercise the machine and associated services as though a plate where being baked; this will operate the machine for the period (programmable) normally 60 minutes for a period of 30 seconds. The automatic programme may be interrupted at any time by the entry of a plate.

The operation of a stop pushbutton or opening of a guard will cause the mains power to be removed from the pumps and drives.

The present invention and parts thereof will now be described in more detail with reference to FIGS. 1 to 14.

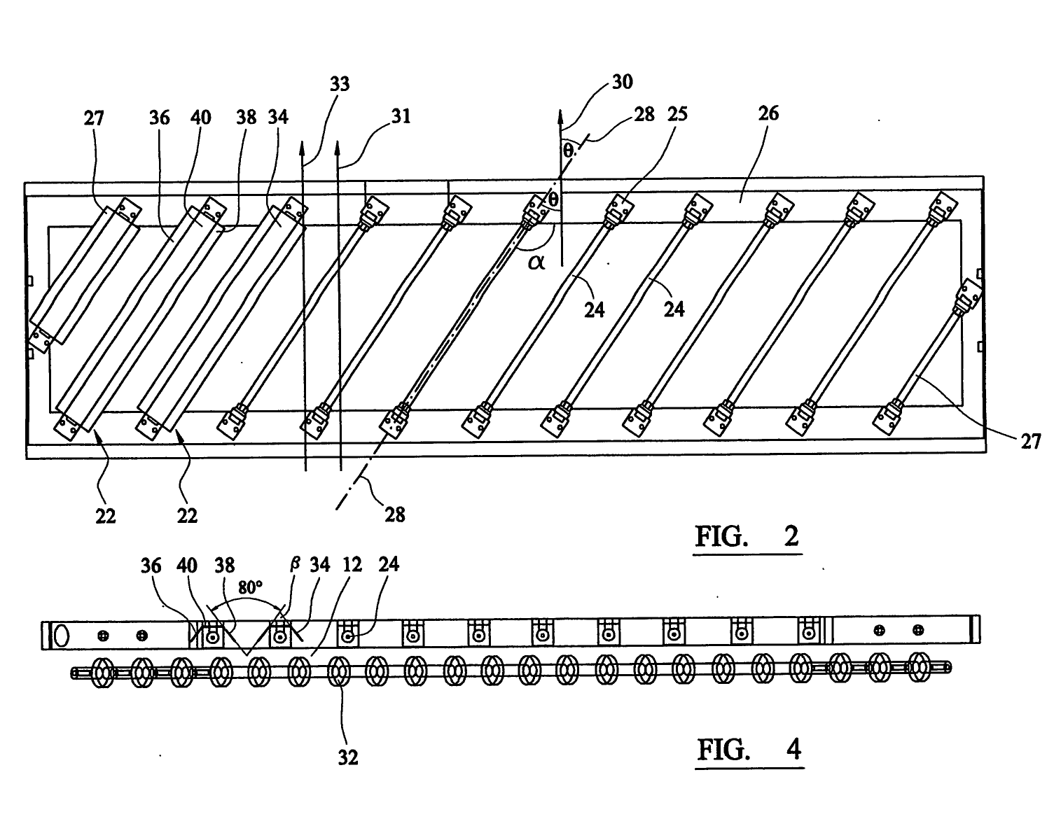

As shown in FIG. 1, the printing plate oven 10 comprises heating apparatus 20 to heat the printing plates 12 whilst in an oven compartment 14. The heating apparatus 20 comprise a plurality of heating elements 22 each including a lamp 24 and preferably comprises a plurality of heating elements 22 comprising a plurality of lamps 24 in order to heat the printing plates 12 as the printing plates 12 pass thereunder. The lamps 12 comprise infra red lamps and more specifically short wave infra red lamps. Each heating element 22 comprises reflective means 34 associated with a respective lamp 24 in order to reflect the radiation from the lamps 12 towards the surface of the printing plates 12 as the printing plates 12 pass underneath the heating elements 22. The printing plates 12 are arranged to pass underneath the lamps 12 at a constant velocity. The heating elements 22 including elongate lamps 24 have a longitudinal axis which extends in a first direction 28, as shown in FIG. 2. The printing plates 12 pass underneath the lamps 24 and travel in a second direction 30 wherein the second direction also extends along a longitudinal axis of the printing plates 12. The printing plates 12 are supported on rollers 32 or other suitable support means in the oven compartment 14. In alternative embodiments, the heating elements 22 may be located below or to the sides of the printing plates. The heating elements 22 locate within an oven compartment 14 of the printing plate oven 10.

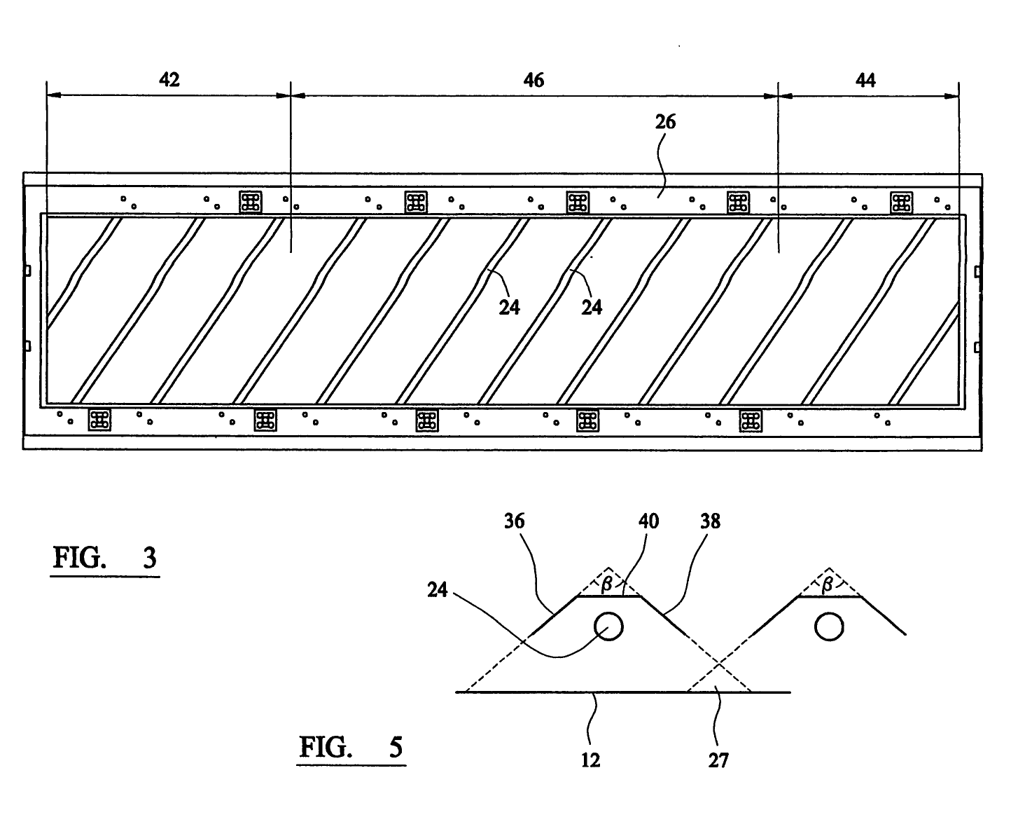

As shown in FIG. 2, FIG. 3, FIG. 4 and FIG. 5, the or each lamp 24 comprises an elongate lamp or strip light which extends along a longitudinal axis 28 of the respective lamp 24. In particular, the lamps comprise halogen infra-red lamps. The lamp may comprise a short wave or medium wave infra-red halogen lamp which is preferably 1 kW or 2 kW. The wavelength of the lamps may be chosen according to the material of the printing plates. The lamps are preferably powered by 240V. The lamps 24 are secured in the heating apparatus 20 by securement brackets or mountings 25 such that the longitudinal axis 28 of each lamp 24 extends in a first direction 28 which is not parallel to a second direction 30 (the direction of the travel of the printing plates 12). Accordingly, the lamps 24 extend at an angle offset to the direction of travel 30 at the printing plates 12 (the longitudinal axis of the printing plate 12). In particular, the angle, θ, between the first direction and the second direction is substantially 35°. Accordingly, the angle α, between the longitudinal axis of a heating element 22 and the lateral axis across the heating apparatus 20 or the lateral axis of the printing plate 12 is substantially 125°.

The heating apparatus 10 comprises an array of heating elements 22 within the oven compartment 14 of the printing plate oven 10. The arrangement of lamps 24 or heating elements 22 in the heating apparatus effectively produces a herring bone pattern. The heating elements 22 are arranged parallel to each other across the lateral width of the heating apparatus.

The heating elements include reflecting means 34 comprising a reflective plate which is formed so as to reflect the heat from a respective lamp 24 downwardly towards the surface of the printing plate 12. The reflecting plate comprises two side sections or walls 36, 38 extending downwardly from an upper section or wall 40 located therebetween at upper parts thereof.

The side sections 36, 38 are angled in order to control and direct the heat. In particular, the reflecting means 34 is arranged to reflect the heat downwardly and within an angle extending outwardly from the lamp 24. In particular, to direct the heat within a predetermined radial angle around the lamp. Accordingly, each heating element 22 effectively produces a “footprint” of heat on the surface of the printing plate 12. Each heating element may have cooling means in particular a fan 39 to dissipate heat away from the respective heating element.

As shown in FIG. 4 and FIG. 5, in the preferred embodiment, the reflecting means 34 maintains the heat substantially within an angle, β, of 80° radially around the heating element 22 or lamp 24 and produces an elongate “footprint” extending angularly across the surface of the printing plate 12. The angle is controlled or set to allow the outermost reflected radiation (or heat footprint thereof) from a first lamp 24 to overlap with the outermost edge of heat reflected (or heat footprint thereof) from a second adjacent lamp 24. The heat generated at the outermost portions is slightly less than that centrally and, therefore, this is compensated by a slight overlap 27 between adjacent lamps 24.

The overlapping portion 27 produces an angled overlapping region extending parallel to the heating elements and preferably provides an overlapping 27 region of substantially 7 mm which extends for substantially the full length of the heating elements 22.

The lamps 24 are angled relative to the first direction 30 such that if a part of the printing plate 12 passes under one end of a lamp 24 at entry then that part of the printing plate 12 will pass under another part of an adjacent lamp 24 before exiting from the heating apparatus (as shown by line 31 in FIG. 2). The longitudinal ends of the lamps 12 do not generate as much heat as the middle sections and, therefore, this is compensated for by passing these parts of the printing plates 12 heated by a longitudinal end of a first lamp under a part of a second lamp 12. It can be seem from FIG. 2 and FIG. 3 that those parts of the printing plates which pass directly underneath a middle section of a lamp will not pass directly under another part of another lamp (as shown by line 22 in FIG. 2) and this prevents or inhibits over baking.

The heating apparatus 20 comprises a plurality of heating elements 22 including lamps 24 extending angularly across the lateral width thereof. The heating apparatus 20 comprises side heating elements 27 including side lamps which are not full length compared to those located centrally. The side heating elements 27 are arranged to heat the lateral sides of the printing plates 12 to ensure that the printing plates 12 receive an even temperature across the whole surface thereof. The side lamps are the same as the central lamps but have a reduced longitudinal length. Again, the side heating elements have respective reflecting means in accordance with the central elements previously described.

The angle and length of the heating elements and in particular the lamps may be varied depending upon the size of printing plate and/or the material of the printing plate. The greater the angle, θ, the longer the heating elements will be needed in general. However, the longitudinal length of the heating apparatus for short printing plates may be less than that required for long printing plates.

If a printing plate is relatively wide compared to its length then the heating elements may be relatively short. Similarly, if a printing plate is relatively long compared to its width then the heating elements may be relatively long. This is to provide even baking of the printing plates.

The heat generated by the lamps 24 is controlled by switching the lamps on and off consecutively, for example the electrical power to the lamps 24 is pulsed. The printing plate oven 10 comprises power control means which enables each individual lamp 24 to be controlled or to group the lamps such that groups provide an even temperature within a particular area.

As shown in FIG. 3 specifically, the lamps 24 are grouped into three which may be called a left hand side group 42 (lateral group 1), a central group 46 and a right hand side group 44(lateral group 2). The central group comprises six full sized lamps (but may comprise between 3 and 8 lamps) whereas the side groups comprise two full length lamps and one reduced length side lamp. However, in alternative embodiments there are any suitable number of groups and lamps within the groups. In particular, there is an odd number of groups extending across the printing plate surface such that there is always a middle section or group that can be controlled relative to the

In general, central parts of a printing plate 12 receive more heat compared to lateral side parts in evenly heated ovens since the heat will conduct towards the central part from the outer parts. Accordingly, the present invention provides control means in order to reduce the power of the lamps 24 in one group compared to another group and, in particular, in the central group 46 compared to the first and second lateral groups 42,44. As explained above, there may be further side groups located between the central group and the outermost lateral group and these intermediary groups may be controlled to produce heat between that supplied by the central group and that of the outermost groups.

Similarly, as the printing plate 12 passes underneath the lamps 24, heat will be automatically transferred to those parts of the plate not yet going through the heating apparatus 20 or oven compartment 14 and, accordingly, in a constantly evenly heated oven compartment 14, the parts of a printing plate 12 located towards the rear may be overcooked or the first part of the printing plates 12 may be undercooked to compensate for this effect.

Accordingly, the present invention provides control means to control the heat from the heating apparatus 20 as a printing plate 12 passes thereunder. In particular, the heat of the lamps 24 is reduced as the printing plate passes therethrough.

As demonstrated in FIG. 6 and FIG. 11 and FIG. 12, in the preferred embodiment, as the front end of the printing plate 12 passes under the lamps 24 the lamps in the lateral groups (through the pulsated electrical supply) 42, 44 are switched on for 95% of the time and off for 5% of the time whereas the lamps 24 in the central group 40 are only on for 90% of the time and off for 10% of the time. This provides a front group of sections.

Once a predetermined length 78 (for example 500 mm) of the printing plate 12 has passed through the (infra red sensor 41), the heat from the lamps 24 is reduced such that the lamps 24 in the lateral groups 42, 44 are on for 85% of the time and off for 15% of the time whereas the lamps 24 in the central group 46 are on for 80% of the time and off for 20% of the time. This provides an intermediary group of sections.

The infra red sensor (infeed sensor 41) then detects the rear edge 50 of the printing plate 12 and reduces the heat once more for a predetermined length of a rear part of the printing plate 12.

In particular, the lamps 24 in the lateral groups 42, 44 are on for 80% of the time and off for 20% of the time whereas the lamps 24 in the central part 46 are on for 70% of the time and off for 30% of the time. This provides a rear group of sections.

Accordingly, the control means ensure that the printing plate is evenly baked and does not produce over baked or under baked areas or sections. In particular, the control means effectively divides each printing plate into nine sections 60, 62, 64, 66, 68, 70, 72, 74, 76 as demonstrated in FIG. 6 and FIG. 11 and FIG. 12.

In alternative embodiments, the particular heat produced can be easily varied by the control means to produce power in each section in the range of 0-100% but in preferred embodiments varies the power for each section between 60-95%. In addition, as noted above, the number of sections can be varied to any suitable number, for example 1, 3, 5, 7, 9 etc in groups located laterally across the printing plate and 1, 2, 3, 4, 5, 6 etc. sections located longitudinally along the printing plate. In particular, relatively large printing plates may require more sections compared to relatively small printing plates. In addition, pre-baking of printing plates may require more sections to control the pre-baking of the printing plates.

The printing plate oven 10 comprises drive means in order to drive and move the printing plates into and/or out of and/or through the oven compartment 14 or any other suitable part of the printing plate oven 10.

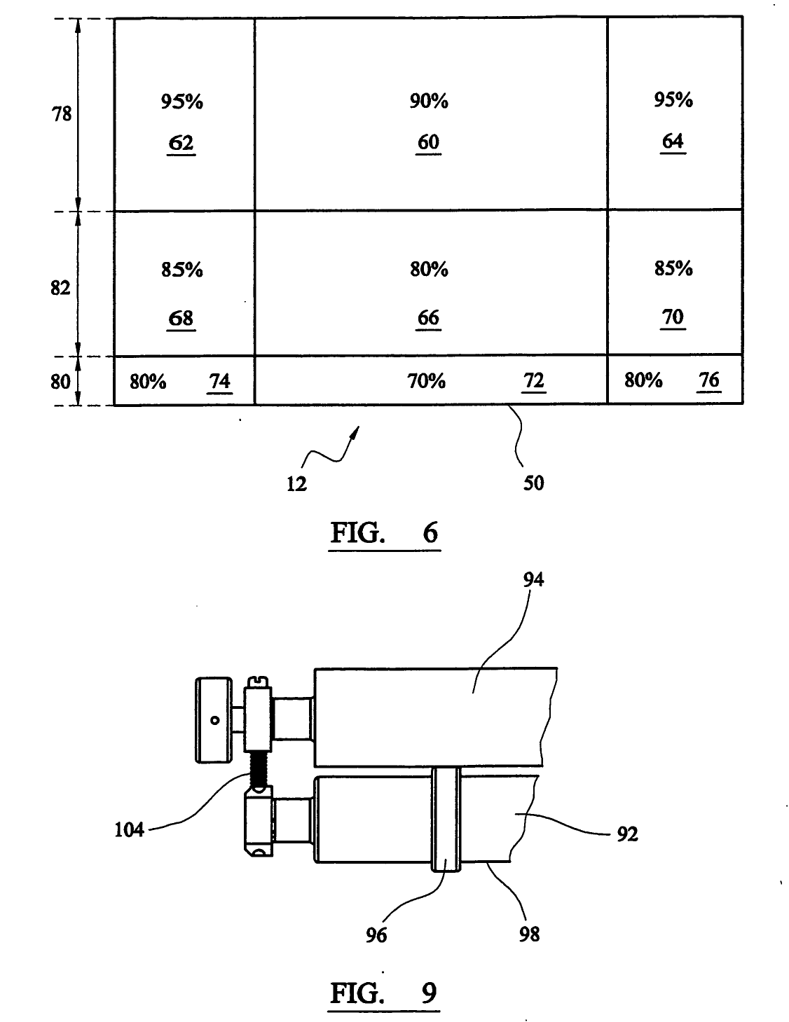

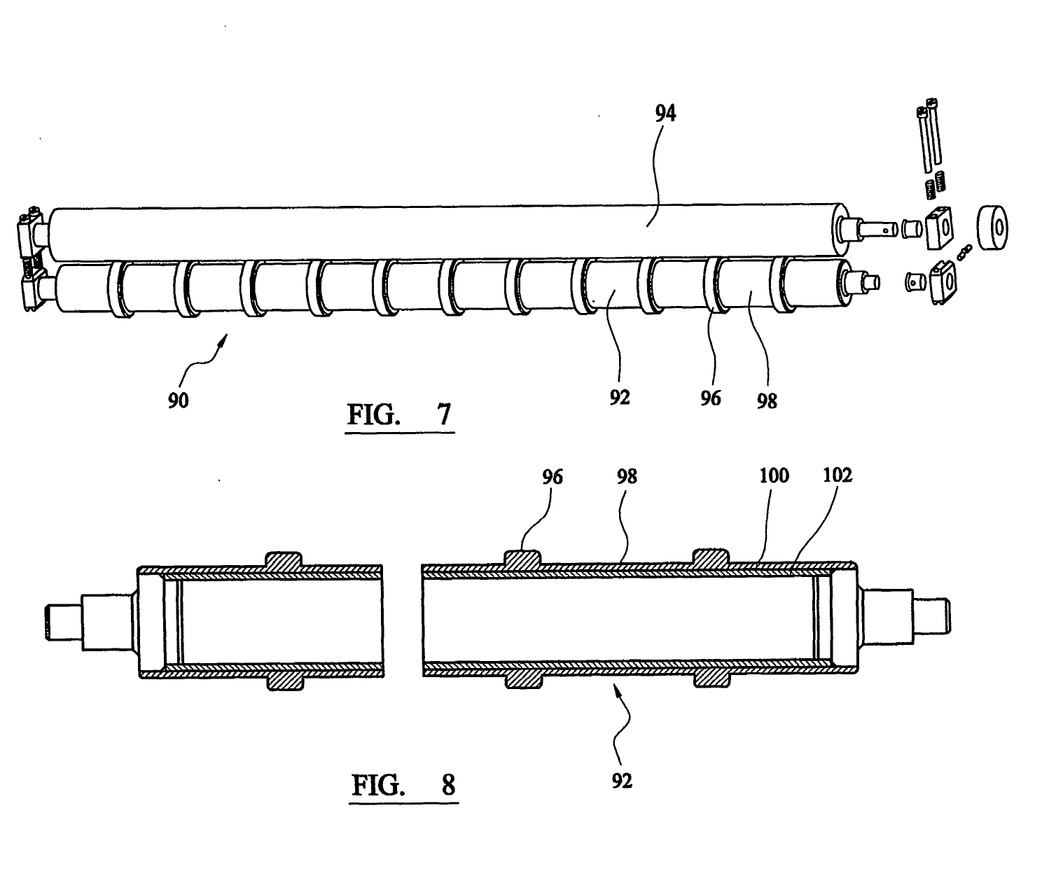

As shown in FIG. 1, FIG. 7, FIG. 8 and FIG. 9, the drive means comprises a drive roller 92 which rotates and moves the printing plates 12. The drive means also comprises urging means which urges the printing plates relatively towards the drive roller 92 in order to efficiently transfer the movement of the outersurface of the drive roller to the printing plates 12. The urging means comprises an urging roller 94 which locates vertically above the drive roller 92. The outer surface of the urging roller 94 is spaced from the outersurface of the drive roller 92 by a predetermined and set distance. Typically, this distance is substantially 0.2 mm. Adjustment means comprising adjustment screws are provided in order to set and adjust the spacing between the co-operating outersurfaces. There is a separation distance between the co-operating outersurfaces when there is no printing plate 12 located therebetween and this distance is even throughout the longitudinal lengths of the urging roller 94 and the drive roller 92.

When the printing plate 12 locates between the drive roller 92 and the urging roller 94 the printing plate moves the outer surface of the urging roller relatively away from the outersurface of the drive roller 92. The outersurface of the drive roller 92 comprises a deformable or resilient material in order to deform when a printing plate 12 locates between the drive roller 92 and the urging means. In the preferred embodiment the outersurface of the urging roller 94 and the drive roller 92 comprises a deformable and resilient material, for example rubber. Accordingly, when a printing plate 12 locates between the drive roller 92 and the urging roller 94 both the outersurfaces of the drive roller 92 and the urging roller deform. The printing plate 12 is effectively squeezed in between the drive roller 92 and the urging roller 94. This ensures that the printing plate remains in contact with the outersurface of the drive roller 92 in order to efficiently transfer the movement of the printing plates 12. Accordingly, the initial separation distance between the outersurfaces of the drive roller and the urging roller is less than the thickness of a printing plate 12. The separate distance can be adjusted by adjustment means in order to adjust the separation distance dependent upon the thickness and/or properties and/or material of the printing plate.

The drive roller 92 comprises raised portion 96 on the outer surface thereof. The preferred embodiment of the drive roller or first roller comprises a plurality of raised portion 96. Adjacent raised portions 96 define channel portions 98 therebetween. The channel portions 98 enable hot gases to flow therethrough in order to prevent over heating of a printing plate 12 passing thereover. In addition, the channel portions 98 do not make contact with the printing plate 12, and, therefore, heat is not transmitted to the printing plate 12 through the conduction of heat at these portions 98. Prior art rollers comprise smooth continuous surfaces which result in the printing plates being heated whilst passing thereover and this causes the printing plates to subsequently overheat. The prior art rollers thereby act as heat sinks and tend to heat the printing plates 12. Since the rollers are solid and do not enable heat to escape this may tend to at least partially bake the printing plates.

The raised portions 96 on the drive roller 92 extend around the full circumference of the drive roller 92 and effectively provide a relatively thin cylindrical surface for contacting the printing plates 12. The drive roller 92 comprises a plurality of raised portions 96 spaced apart along the longitudinal length of the drive roller 92. In particular, the drive roller 92 comprises 11 raised portions 96.

The drive roller 92 is driven by an electric motor which subsequently moves the printing plates 12 into or out of the oven compartment 14.

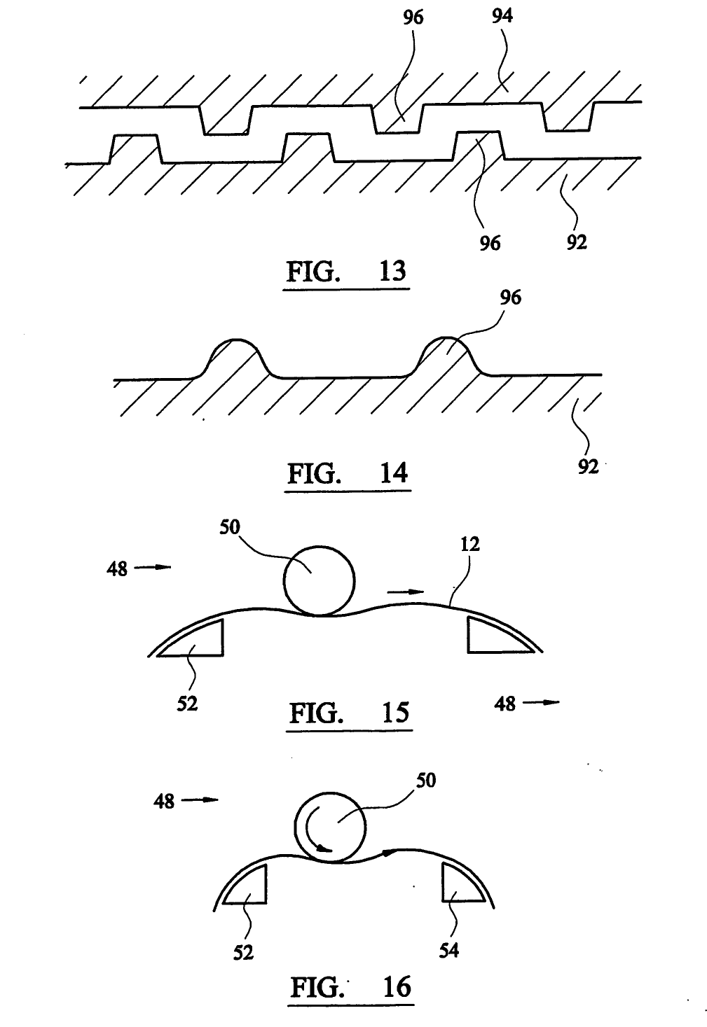

As shown in FIG. 8, in a longitudinal cross-section the upper surface (i.e. contact surface when the drive roller is located below the urging means) of the drive roller 92 is castellated. However, other shaped raised portions would also be suitable, for example smooth raised portions as shown in FIG. 14. The drive roller 92 comprises an outer sleeve 100 providing the raised portions 96 engaged over an inner sleeve 102.

The drive roller 92 may be located above the urging means in an embodiment.

In one embodiment, an urging roller may be used having raised portions together with a smooth drive roller. Accordingly, one rill still provides means for heat escape and one roller provides the drive.

The urging roller 94 comprises a free-wheeling roller which is rotated by movement of the printing plate 12 thereunder or thereover.

The urging roller 94 may comprise raised portions and channel portions to prevent or inhibit the transfer of heat to the printing plate. Such raised portions and channel portions may be an alternative to providing raised portions 96 and channels portions 98 on the drive roller 92 or may be in addition to the raised portions 96 and channel portions 98.

As shown in FIG. 14, in one embodiment, raised portions provided on the urging roller are longitudinally offset from the raised portions 96 of the drive roller 92. Accordingly, any single part of a printing plate 12 is not contacted or supported simultaneously from above and below. Again, this further prevents the transfer of heat to the printing plates 12.

As shown in FIG. 1 and FIG. 15 and FIG. 16, the printing plate oven 10 comprises cooling means 48 to cool the printing plates 12 once the printing plates 12 have passed through the oven compartment 14.

The cooling means 48 is arranged to cool the printing plates whilst the printing plates are in tension which is produced by (slightly) flexing the printing plates 12. This flexion whilst cooling prevents or inhibits the printing plates 12 from rippling whilst cooling. The printing plates 12 are flexed across the lateral width thereof which prevents any flexion or rippling occurring and especially in the longitudinal direction of the printing plates 12. In prior art cooling means, the printing plates are not flexed or in tension and ripples tend to be produced especially with the grain of the printing plate. The present invention is arranged to prevent any ripples occurring that are greater than approximately 3 mm in height.

The cooling means 48 comprises a deflection member in the form of a deflection roller 50 which locates between a first guide member 52 and a second guide member 54. The printing plate 12 is arranged to abut and co-operate with the first guide member 52 and to be guided towards the outer surface of the deflection roller 50. The surface of the deflection roller 50 locates at the same height or lower than the upper guide surface of the first guide member 52. The deflection roller flexes the printing plate 12 downwardly. The printing plate 12 flexes at a lower surface of the deflecting roller towards the second guide member, as shown in FIG. 1, FIG. 15 and FIG. 16. In one embodiment, the printing plate may flex around a lower portion (and specifically a lower arcuate portion) of the deflection roller 50 and is then directed towards the second guide member 54. The upper surface of the second guide member 54 is located above the lower surface of the deflection roller 50. The printing plate 12 is then driven over the surface of the second guide member 54 and towards a gumming section.

In a preferred embodiment, the deflection roller 50 is not driven but freely rotates as a printing plate 12 passes thereunder. In an alternative embodiment, the deflection roller 50 is driven. Driven deflection rollers may enable greater tension and flexing to be applied to the printing plates 12 by forcing a greater flexion angle in the printing plates.

As shown in FIG. 15 and FIG. 16 the printing plate 12 is guided by a first guide member 52 towards a deflection member comprising a freely rotating deflection roller 50. The roller may have a deformable and/or resilient outersurface. The deflection roller deflects the printing plate towards a second guide member 54 such that the printing plate is flexed and is in tension along a lateral axis across the lateral width thereof. The or each guide members 52, 54 comprises plastic angled strips which may be at an angle of between 30° and 45° and preferably substantially 33°. The guide members provide support surfaces for the underneath of the printing plates.

The printing plate will cause rotation of the deflection roller. The guide member may provide angled support surfaces 52, 54 below the printing plate. In the preferred embodiment, the guide members only provide support surface 52, 54 from below. In addition, the deflection roller may be driven in order to flex and tense the printing plate by a greater amount. The printing plate may just contact a relatively short area or short arcuate surface of the deflection roller. However, the printing plate may be caused to flex around an arcuate portion of the deflection roller.

The oven compartment 14 comprises ambient temperature regulation means in order to regulate the ambient temperature within the oven compartment 14. The ambient temperature regulation means comprises a heat sensor located within a part of the oven compartment and in particular in a flow part of the oven compartment where ambient air is flowing. If the ambient temperature rises by a predetermined amount, for example by greater than 1° C., then the temperature regulation means is arranged to cool the ambient air temperature in order to retain the ambient temperature within a predetermined range, i.e. within 1° C.

This is particularly useful for long print runs where the ambient air temperature in the oven compartment 14 would tend to rise. This would occur when preparing printing plates for full colour prints where several plates (for example 4 or 8) may be baked consecutively within a run. In addition, runs may be used to prepare numerous printing plates.

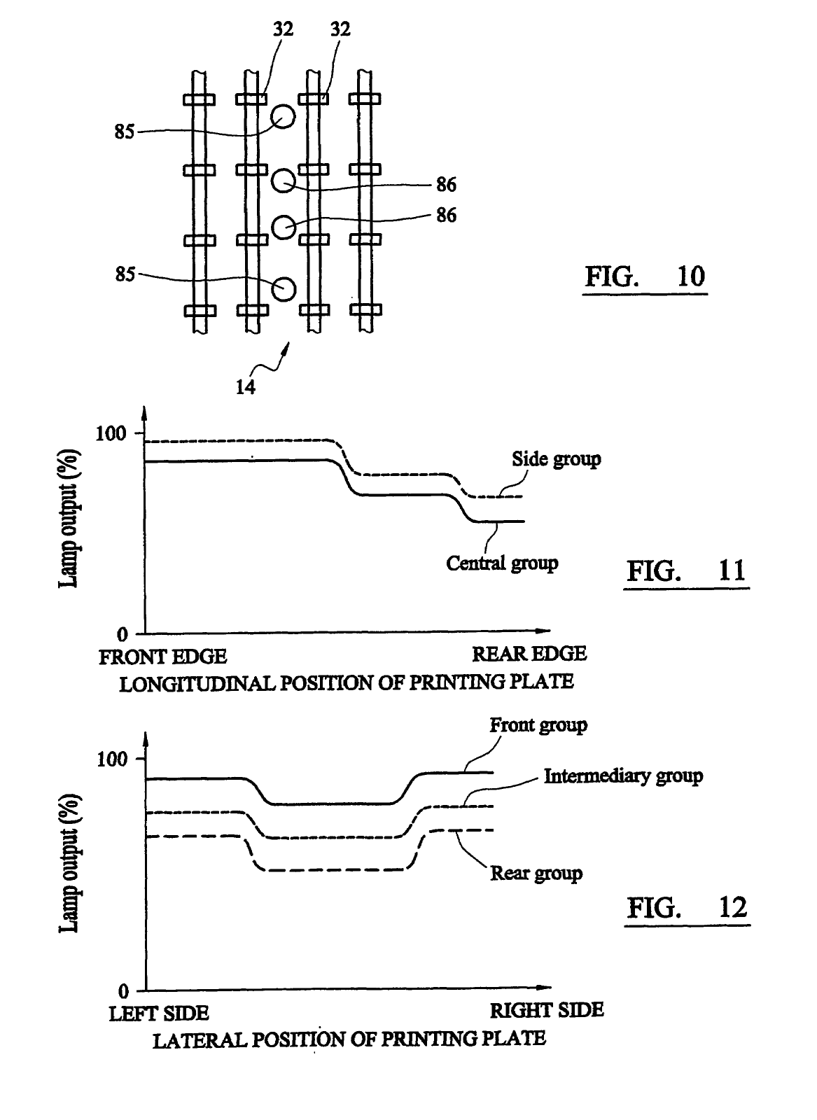

As shown in FIG. 10, the temperature regulation means comprises an exhaust or a plurality of exhausts or exhaust ports 85, 86 (or extraction ports) which is or are arranged to remove hot air and/or fumes from the oven compartment 14 once the temperature has risen above the set or predetermined valve.

The exhaust means comprises two fans and four exhaust ports 85, 86 located within the oven compartment 14. Accordingly, as soon as the temperature has risen by greater than 1° C. the exhaust ports are opened and the fans are operated until a temperature sensor within the oven compartment 14 detects and senses that the selected ambient temperature has been restored. In prior art printing plate ovens, the ambient air temperature is not regulated and, particularly, in large continuous runs, the ambient temperature within the oven compartment 14 will rise as the printing plates pass through the oven compartment 14. This will overbake the later baked printing plates and/or under bake earlier baked printing plates.

As shown in FIG. 10, the oven compartment 14 comprises extraction or exhaust ports 85, 86 which are arranged to remove hot air and fumes from the oven compartment 14. In a preferred embodiment, the oven compartment 14 has two side extraction ports 85 and two central extraction ports 86. The two side extraction ports 85 are continuously open and are associated with a first fan to enable hot air and fumes to be continuously extracted from the oven. These are in communication with the first fan. The two central extraction (or exhaust) ports 86 are selectively opened and closed by ambient temperature regulation means and are associated with a second fan. Rather than physically opening and closing the ports the fan may be switched on and off the effectively open these ports. However, in one embodiment the ports may be both physically opened and closed and the second fan may also be switched on and off. The ambient temperature regulation means comprises a temperature sensor located within the oven compartment which detects and senses the ambient temperature within the oven compartment 14. Once the ambient temperature rises above a selected temperature by which temperature regulation means opens the central exhaust ports 86 in order to remove hot air. The central ports 86 may be in communication with one or more fans to extract the hot air and fumes. This reduces the temperature of the ambient air within the oven compartment 14. The temperature sensor continues to sense and detect the ambient temperature and once this falls to a set level the exhaust ports 86 are closed and/or the second fan is switched off to prevent the ambient temperature falling below a predetermined level. This thereby produces a cycle whereby the ambient air temperature rises, the central exhaust ports 86 open and/or the second fan is switched on, the ambient air temperature falls and the central exhaust ports 86 close and/or the second fan is switched off. This cycle maintains the ambient air temperature within the oven compartment 14 within a predetermined range, for example within 1° C. or 2° C. or 5° C. or 10° C. of a selected ambient air temperature level.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. Heating apparatus for a printing plate oven comprising at least one heating element extending in a first direction wherein a printing plate is arranged, in use, to pass the heating element in a second direction which is at an angle to the first direction.

2. Apparatus according to claim 1 in which the heating element comprises a substantially linear heating element.

3. Apparatus according to claim 2 in which the linear heating element comprises a longitudinal axis which extends in the first direction.

4. Apparatus according to claim 1 in which the printing plate is arranged, in use, to pass underneath the or each heating element.

5. Apparatus according to claim 1 in which the heating apparatus comprises a plurality of heating elements.

6. Apparatus according to claim 5 in which each heating element comprises a longitudinal axis which extends in the first direction.

7. Apparatus according to claim 1 in which the or each heating element comprises a lamp.

8. Apparatus according to claim 7 in which the or each heating element comprises an infra-red lamp.

9. Apparatus according to claim 7 in which the or each lamp comprises a halogen lamp.

10. Apparatus according to any claim 7 in which the or each lamp is pulsated in order to control the heat generated by the respective lamp.

11. Apparatus according to claim 1 in which the angle between the first direction and the second direction is less than or equal to substantially 70°.

12. Apparatus according to claim 1 in which the heating elements are arranged spaced apart laterally across the heating apparatus.

13. Apparatus according to claim 1 wherein, if a part of a printing plate passes underneath a first end of a first heating element then said part of the printing plate passes underneath a second end of a second (adjacent) heating element.

14. Apparatus according to claim 1 in which the or each heating element comprises a first end which is located upstream of second end of the respective heating element such that a printing plate is arranged, in use, to pass underneath the first end of the heating element and subsequently underneath the second end of the heating element.

15. Apparatus according to claim 1 in which the heating apparatus comprises a first group of heating elements located centrally laterally in the heating apparatus and one right group and one left group of heating elements located adjacent to the lateral edges of the heating apparatus.

16. Apparatus according to any preceding claim 1 in which the or each heating element comprises reflecting means.

17. Apparatus according to claim 16 in which the or each reflecting means is located above the respective heating element.

18. Apparatus according to claim 16 in which the reflecting means comprises a first side wall and a second side wall in order to direct the heat.

19. Apparatus according to claim 16 in which the reflecting means maintains and reflects the heat radially out from the respective heating element within an angle and wherein the angle is substantially 80°.

20. Apparatus according to claim 16 in which the reflecting means reflects the heat downwardly towards an upper surface of a printing plate, in use.

21. Apparatus according to claim 1 in which the heating apparatus comprises an array of heating elements wherein the longitudinal axes of the heating elements are parallel.

22. Apparatus according to claim 21 in which the heating elements form a herring bone pattern within the heating apparatus.

23. Apparatus according to claim 1 in which the heating apparatus comprises cooling means.

24. Apparatus according to claim 23 in which the cooling means is arranged, in use, to cool the or each heating element.

25. Apparatus according to claim 16 in which the reflecting means is arranged such that the heat reflected from a first heating element overlaps on a surface of a printing plate, in use, with the heat reflected from an adjacent heating element.

26. A method of heating printing plates in an oven compartment of a printing plate oven comprising heating at least one heating element wherein the heating element extends in a first direction and moving a printing plate passed the heating element in a second direction which is at an angle to the first direction.

27. A method according to claim 26 in which the method comprises passing the printing plate underneath the heating element.

28. A method according to claim 26 in which the method comprises providing a plurality of heating elements in the heating apparatus.

29. A method according to claim 26 in which the method comprises providing an array of heating elements in a herring bone pattern in the heating apparatus.

30. Drive means for a printing plate, the drive means being arranged, in use, to drive a printing plate wherein the drive means comprises a first roller and the first roller comprises an outer surface for contacting the printing plate in which the outer surface of the roller comprises at least one raised portion.

31. Drive means according to claim 30 in which the drive means is for use in a printing plate oven.

32. Drive means according to claim 30 in which the first roller comprises a drive roller which is driven.

33. Drive means according to claim 30 in which the outer surface of the first roller comprises a plurality of raised portions.

34. Drive means according to claim 30 in which the or each raised portion extends radially around the outer surface of the first roller.

35. Drive means according to claim 34 in which the or each raised portion extends completely radially around the outer surface of the first roller to provide a cylindrical support surface.

36. Drive means according to claim 30 in which the drive means comprises urging means to urge the printing plate towards the first roller, in use.

37. Drive means according to claim 36 in which the urging means comprises a second roller.

38. Drive means according to claim 37 in which the outer surface of the second roller is spaced from the outer surface of the first roller by a distance slightly less than the thickness of a printing plate to be driven therethrough.

39. Drive means according to claim 37 in which the second roller is biased relatively towards the first roller.

40. Drive means according to claim 30 in which the outer surface outer surface of the first roller comprises a deformable or resilient material.

41. Drive means according to claim 30 in which the urging means comprises a second roller wherein the outer surface of the second roller comprises at least one raised portion.

42. Drive means according to claim 41 in which the or each raised portion on the second roller extends radially around the outer surface of the second roller.

43. Drive means according to claim 41 in which the second roller has an outer surface contoured or shaped identical to the first roller.

44. Drive means according to claim 43 in which the raised portions of the second roller are off set longitudinally along the urging roller in order for a raised portion in one roller to locate within a channel portion defined between two adjacent raised portions on the other roller.

45. Drive means according to claim 30 44 in which adjacent raised portions on the or each roller define a channel portion therebetween.

46. Drive means according to any one of claim 36 when dependent upon claim 3Gm which the first roller has raised portions which are offset laterally with raised portions of the urging means.

47. Drive means according to claim 46 in which the raised portions are offset such that a part of a printing plate is not contacted simultaneously on both surfaces.

48. A method of driving a printing plate, the method comprising driving a roller to drive the printing plate wherein the roller comprises an outer surface for contacting the printing plate in which the outer surface of the roller comprises at least one raised portion.

49. A method according to claim 48 in which the method comprises urging the printing plate into contact with the outer surface of the roller.

50. A method according to claim 48 in which the method comprises passing the printing plate between two rollers wherein one of the rollers is driven.

51. Cooling means for use with a printing plate oven wherein the cooling means comprise deflection means in order to flex a part of a printing plate during cooling.

52. Cooling means according to claim 51 in which the cooling means applies a tensile force to a printing plate during cooling.

53. Cooling means according to claim 51 in which the deflection means comprises a deflection member.

54. Cooling means according to claim 51 in which the deflection means comprises guide means.

55. Cooling means according to claim 54 in which the guide means guides the printing plate in a first direction and is arranged to guide the printing plate in order to abut the deflection member which flexes and deflects the printing plate in order for the printing pl˜te to travel in a second direction.

56. Cooling means according to claim 51 in which the deflection means comprises a deflecting roller.

57. Cooling means according to claim 56 in which the printing plate is arranged to pass between a first guide member around an arcuate part of an outer surface of the deflecting roller and to a second guide member.

58. Cooling means according to claim 57 in which the first guide member is spaced from the second guide member by a distance less than the longitudinal length of the printing plate.

59. Cooling means according to claim 51 in which the printing plate is flexed laterally across the width thereof during cooling.

60. Cooling means according to claim 56 in which the deflecting roller comprises a driven deflecting roller.

61. A method of cooling a printing plate comprising flexing at least a part of the printing plate during cooling.

62. A method according to claim 61 in which the method comprises tensing at least a part of the printing plate during cooling.

63. A method according to claim 61 in which the method comprises flexing the printing plate over a lateral direction.

64. Heating apparatus for a printing plate oven comprising heating apparatus and control means wherein the control means is arranged, in use, to control the heat of the heating apparatus relative to a part of a printing plate passing therethrough.

65. Heating apparatus according to claim 64 in which the part comprises a section which may be defined on the printing plate due to the location of the part relative to its longitudinal and/or lateral position on the printing plate.

66. Heating apparatus according to claim 64 in which the control means is arranged, in use, to control the heat of the heating apparatus relative to the longitudinal position of the printing plate which is located in the heating apparatus.

67. Heating apparatus according to claim 64 in which the heating apparatus is arranged to simultaneously provide a first temperature to one part of the printing plate and a second temperature to another part of the printing plate.

68. Heating apparatus according to claim 67 in which the heating apparatus is arranged to simultaneously provide a third temperature to a third part of the printing plate.

69. Heating apparatus according to claim 64 in which the control means controls the heat of the heating apparatus in a first period which is an entry period.

70. Heating apparatus according to claim 69 in which the control means controls the heat of the heating apparatus in a second period which is an exit period.

71. Heating apparatus according to claim 70 in which the control means controls the heat of the heating apparatus in a third period which is an intermediary period between the entry period and the exit period.

72. Heating apparatus according to claim 64 in which the control means is arranged to control the heat of the heating apparatus in a plurality of periods or sections whilst the printing plate is passing through the heating apparatus.

73. Heating apparatus according claim 64 in which the control means controls the heat supplied by a plurality of heating elements in the heating apparatus.

74. Heating apparatus according to claim 64 in which the control means is arranged to supply heat to a printing plate such that the printing plate is defined in a plurality of zones wherein each zone is arranged to be supplied with a different amount of heat.

75. Heating apparatus according to claim 74 in which the printing plate is divided into a plurality of lateral sections such that the heat supplied to outermost side sections is greater than that applied to the other sections located between the outermost side sections.

76. Heating apparatus according to claim 64 in which the printing plate is divided such that an intermediary section locates between a front section and a rear section.

77. Heating apparatus according to claim 76 in which the heat applied to the intermediary section is less than that applied to the front section but is greater than that applied to the rear section.

78. A method of controlling heating apparatus of a printing plate oven comprising controlling the heat applied to the printing plate and varying the heat relative to a part of a printing plate passing through heating apparatus.

79. A method according to claim 78 in which the method comprises varying the heat laterally across the heating apparatus.

80. A method according to claim 78 in which the method comprises varying the heat as a printing plate passes therethrough in order to heat the printing plate dependent upon the longitudinal location of the printing plate in the heating apparatus.

81. Ambient temperature regulation means for a printing plate oven comprising sensor means wherein the sensor means is arranged to sense the ambient temperature within an oven compartment of the printing plate oven and to cool the oven compartment of the printing plate oven when a predetermined ambient temperature is reached.

82. Ambient temperature regulation means according to claim 81 in which the ambient temperature regulation means comprises exhaust means.

83. Ambient temperature regulation means according to claim 82 in which the exhaust means comprises a plurality of exhaust ports.

84. Ambient temperature regulation means according to claim 83 in which the exhaust ports are operable in order to enable fluid communication between the oven compartment and an external atmosphere.

85. Ambient temperature regulation means according to claim 83 in which the exhaust port(s), once opened, is arranged, to be closed when a predetermined ambient temperature has been reached.

86. Ambient temperature regulation means according to claim 83 in which the temperature regulation means is arranged to maintain the ambient temperature of the oven compartment within a predetermined range or below a set temperature relative to a selected ambient temperature.

87. A method of regulating the ambient temperature in an oven compartment of a printing plate oven comprising sensing the ambient temperature within the printing plate oven and cooling the ambient temperature when a predetermined temperature is sensed by the sensing means.

88. A method according to claim 87 in which the method comprises exhausting part of the air of the oven section.

89-98. (canceled)
